(19) United States
(12) Patent Application Publication
(10) Pub. No.: US 2006/0059756 A1
(43) Pub. Date: Mar. 23, 2006

(54) Pictorial label for a container and method of employing the same

(76) Inventor: Jan-Marie Wells, Tustin, CA (US)

Correspondence Address: Daniel L. Dawes;Myers Dawes Andras & Sherman LLP, Suite 1150, 19900 MacArthur Boulevard, Irvine, CA, 92612, US

(21) Appl. No.: 11/142,427

(22) Filed: Jun. 1, 2005

Related U.S. Application Data
(60) Provisional application No. 60/576,516, filed on Jun. 1, 2004.

(51) Int. Cl. G09F 3/20

(52) U.S. Cl. 40/654.01

(57) ABSTRACT

Pictorial labels for shoes are generated at the point of sale by photographing one or more of the shoes either with a Polaroid photograph or a digital camera to imprint the image of the purchased shoe onto a card. The card is then placed in a holder which hangs on, is clipped to, or is adhered to the end of the shoebox, containing the shoes which have been photographed. In the preferred embodiment the holder is clear plastic and includes a hanger which clips onto the edge of the shoebox with the photograph displayed through the transparent holder. Other embodiments include holders adhered to the shoebox by tape, open holders with side rails for retaining the photo within an open-sided pocket, and curved holders to provide compression clips retain the photo in the holder.

### BACKGROUND OF THE INVENTION

1. Field of the Invention

The invention relates to the field of storage containers and more particularly to the label to providing a custom pictorial depiction of the elements stored within the container and a method of employing the same.

2. Description of the Prior Art

Shoes, like any other item of apparel, serve both functional as well as astethetic purposes. Particularly in women's fashions, shoes play as large a fashion role as well as providing a functional foot covering. Also, the cost of women's shoes can in many cases be substantially less than men's shoes because of the differences in structure and materials. As a consequence of both lower price and higher fashion utility, it is not uncommon for female consumers to acquire and wear a variety of shoe styles to match or accent their wardrobe. Thus, a given pair of shoes will often not be worn daily, but will be worn according to the various wardrobe selections made from day to day As a consequence, there is an advantage to the consumer if the shoes, like the garments of the wardrobe, can be stored and made accessible for selection.

Many devices have been provided to assist in both storage and selection of shoes as an element of a fashion wardrobe. Such devices include shoetrees, cabinets having an array of shoe-sized compartments, transparent plastic shoeboxes and the like. In addition to buying specialized devices for the storage and display of shoes, many women simply retain the original cardboard shoebox for storage of the shoe and stack the shoe boxes in a closet with a written description of the color and style of the shoe written on the end of the shoe box. The collection of annotated cardboard shoeboxes provide a flexibility to both increase and decrease the storage assembly, which is lacking in other storage options such as shoe trees and shoe cabinets. The practical accessibility of the shoes using marked shoeboxes, however, will vary widely depending upon the specificity and clarity of the annotation written on the end of the shoebox. Regardless of how specific or careful the annotation may be, there is always at least one fashion characteristic of the shoe that can not be characterized in the brief annotation, such as details of style, buckle, ornamentation and the like.

Therefore, what is needed is some means whereby a more explicit and complete description for labeling may be provided of shoes containing within a conventional shoebox without relying upon the specificity of the annotation.

### BRIEF SUMMARY OF THE INVENTION

The invention is a pictorial label for use of the shoebox comprising an image of at least one shoe can be stored in such shoebox, and a holder for receiving the image attached to such shoebox. The image is a Polaroid photograph taken at the point of sale. The holder is attachable by a user, typically at the point of sale, and is adapted to receive the image at the point of sale. The holder defines a pocket for containing the image and a hanger for attachment to the shoebox.

In one embodiment the pocket comprises a containment which is closed on five sides and opened on an upper sixth side through which the image is inserted. In particular, the pocket comprises a containment comprised of a back panel, a front panel and a bottom portion between the front and back panels. The bottom portion may support the image while the front and back portions maintain the image there between.

Another feature of the invention is a clip or a modification of the containment to function as a clip to fictionally engage the image to retain the image within the containment.

The containment my be integrally formed or comprised of separate pieces fixed together. In the embodiment where the holder is integral, it has a front portion and the front panel of the containment which comprises a single integral panel extending across substantially the entire front portion of the holder. In another embodiment the front panel of the containment is comprised of two spaced apart front rails for retaining the image therein, which rails may be separate or integral.

The hanger may further comprise an integral extension of the back of the pocket. Alternatively the hanger may comprise a back and a separate extrusion fixed to the back of the pocket. Still further, the hanger may comprise double sticky tape adhered to the back surface of the pocket.

The holder may have indicia areas on a front surface thereof for display of markings.

The invention is also characterized as a method for providing a pictorial label for merchandise enclosed within a container at the point of sale comprising the steps of creating a tangible record of an image of at least a portion of the merchandise to provide a pictorial depiction thereof. The record is disposed within a holder. The holder permits visual display of the record. The holder is then attached to the container of the merchandise.

The attachment may be performed in several ways. The preferred method is to attach the holder to the container by hanging the holder on an edge of the container. Another way is to adhere the holder to the exterior surface. More specifically, the invention is a method performable at the point of sale for providing a photographic label for shoes enclosed within an original shoebox comprising the steps of photographing at least one shoe contained within the shoebox to display characteristics of the shoe, which displayed characteristics are used for selection of the shoe for wearing. The photograph is disposed or placed within a holder. The holder is constructed so as to permit visual display of the photograph. The holder is attached to an end of the shoebox to visually display the shoes intended to be stored within the shoebox.

The step of disposing the photograph may comprise disposing the photograph within a holder by frictionally engaging the photograph between two panels one of which is substantially transparent to allow visual display of the photograph.

The invention now having been briefly summarized can be better visualized by turning to the following drawings where in like elements are referenced by like numerals.

### BRIEF DESCRIPTION OF THE DRAWINGS

FIG. 1 is a perspective view of first embodiment of the invention showing the label attached to a conventional shoebox.

FIG. 2 is a perspective view of the label of FIG. 1 shown in isolation of the shoebox.

FIG. 3 is a second embodiment of the invention showing a label attached to the shoebox, which label is integral in construction.

FIG. 4 is a perspective view of the second embodiment of FIG. 3 shown in isolation of the shoebox.

FIG. 5 is a perspective view of the third embodiment of the label in which the front panel of the photo pocket is opened.

FIG. 6 is a perspective view of a fourth embodiment of the label in which the panel construction is simplified and the hanger is an extruded piece glued to the back of the label.

FIG. 7 is a perspective view of a fifth embodiment of the invention similar to that of FIG. 6 with the exception that the front lip of the front panel is bent outwardly.

FIG. 8 is a perspective view of yet another embodiment of the invention in which the label construction is simplified still further and the attachment of the label to the shoebox by means of a double sticky tape.

FIG. 9 is a perspective view of still yet another embodiment of the invention in which the hanger for the holder is glued to or extruded as part of the back panel of the label,

FIG. 10 is a perspective view of another embodiment of the invention in which the hanger is glued to or extruded from the front panel of the label.

FIG. 11 is a perspective view of another embodiment of the invention in which the hanger is formed from a backwardly curved portion of the front panel of the label.

These and other embodiments of the invention may now be better understood by turning to the following detailed description.

### DETAILED DESCRIPTION OF THE PREFERRED EMBODIMENTS

Pictorial labels for shoes are generated at the point of sale by photographing one or more of the shoes either with a Polaroid photograph or a digital camera to imprint the image of the purchased shoe onto a card. The card is then placed in a holder which hangs on, is clipped to, or is adhered to the end of the shoebox, containing the shoes which have been photographed. In the preferred embodiment the holder is clear plastic and includes a hanger which clips onto the edge of the shoebox with the photograph displayed through the transparent holder. Other embodiments include holders adhered to the shoebox by tape, open holders with side rails for retaining the photo within an open-sided pocket, and curved holders to provide compression clips retain the photo in the holder.

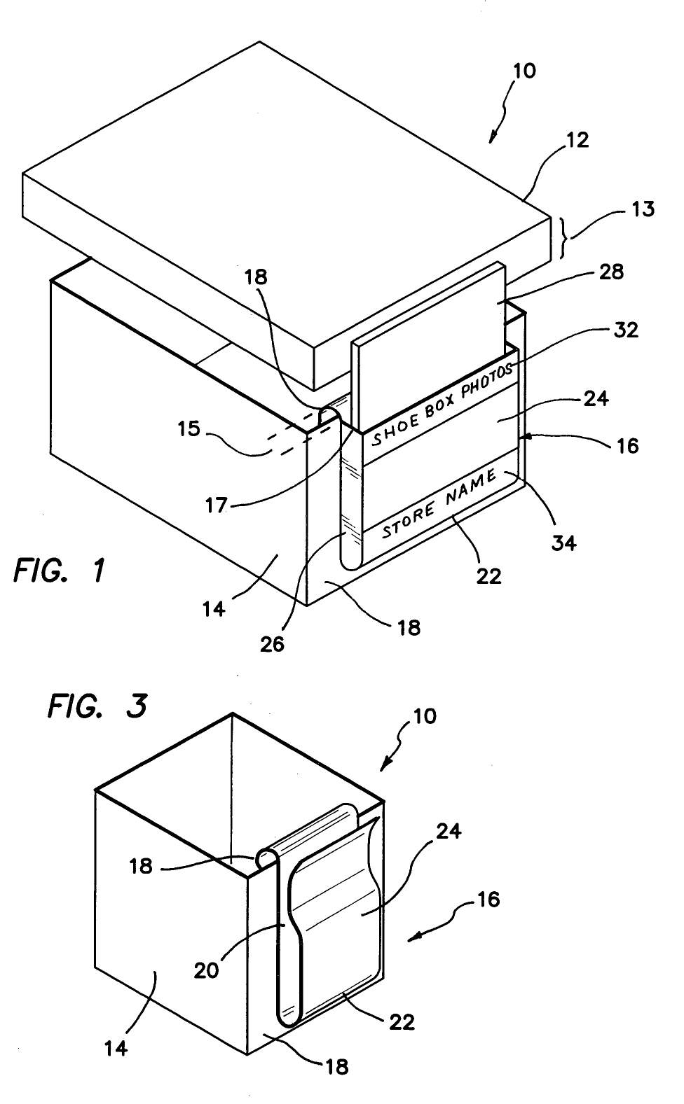

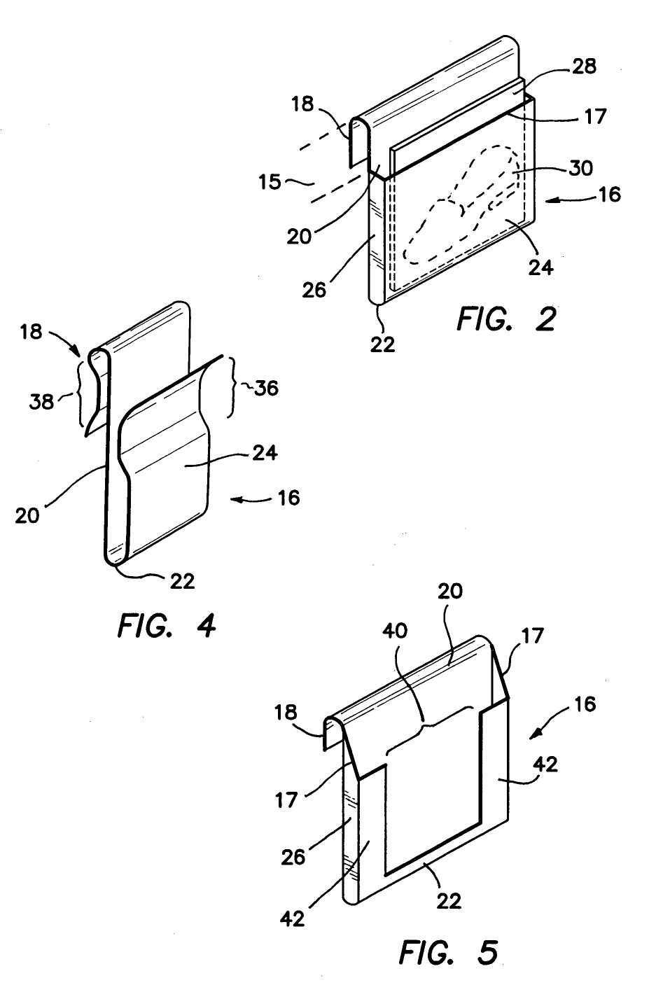

FIG. 1 is a perspective view of a first embodiment of the invention as applied to a conventional cardboard shoebox 10. The illustrated embodiment of shoebox 10 is comprised of a cardboard lid 12 and a bottom 14. This contemplates that lid 12 may or may not be combined with bottom 14 when the shoes, not shown, are stored in the labeled box 10. The label, generally denoted by reference 16, is attached to one end 18 of bottom 14 typically by means of a hanger 18 better shown in the embodiment to FIG. 1 and in the perspective view of FIG. 2. Label 16 in the first embodiment is composed of molded clear plastic, such as a clear acrylic. Turning specifically to FIG. 2, label 16 is comprised of a hanger 16 integrally formed from a rear panel 20 of label 16 which continues to a curved or round bottom portion 22 of label 16 which curves forwardly and upwardly to define a front panel 24 and two opposing ends 26, one of which is seen in FIG. 2. Rear panel 20, side panels 26, front panel 24 and bottom portion 22 together form a substantial enclosure or pocket into which a card or photograph 28 can be easily inserted or slipped. In the preferred embodiment photograph 28 is a Polaroid photograph of the shoe 30 which is stored within box 10. Any type of image may be included or substituted for photograph 28, including digital images, preprinted images and the like, although the illustrated embodiment contemplates an image that is fabricated at the point of sale, usually at the time of sale.

Distance 15 between the top hanger 18 and the top of sides 26 and front panel 24 is chosen so as to equal or exceed the depth of 13 of box led 12 so that when lid 12 was placed upon bottom 14, it overlaps hanger 18 and descends to or near top edge 17 of sides 26 and front panel 24. This allows box lid 12 to be placed on bottom 14 of box 10 and to fit securely on bottom 14 while label 16 remains attached to end 18. Box 10 with label 16 can thus be stored and stacked within a closet with labels 16 showing to allow easy and quick visual identification of the appropriate box 10 and a collection containing the depicted shoes.

Front panel 24 of label 16 may also be provided with areas of indicia display 32 and 34 which have text, logos, graphics or the like silk screened or otherwise permanently printed, engraved or fixed on either the front or back surface of front panel 24. For example, an upper display area 32 may be provided for a trademark for label 16, such as Shoebox Photo™, while lower display area 34 can be provided for the name of the retailer who sells the shoe, label 16 and provides the service of taking photograph 30 of the shoe and providing it with label 16 to the customer. In any case, an image 30 of the shoe will be clearly displayed beneath transparent panel 24 as depicted in FIG. 2 and may be seen in whole or part through indicia areas 33 and 34 depending upon the design chosen. Regardless of the obscuration or lack of obscuration provided by indicia areas 32 and 34, shoe 30 will be visible in a view which shows its principal fashion elements to allow the quick and accurate identification of the appropriate box 10 in which shoe 30 is stored.

It must be understood that many types of modifications may be made to label 16 without departing from the spirit of the scope of the invention. A few of these modifications are shown in the FIGS. 3-9. For example turning to FIG. 3 a second embodiment of label 16 is depicted disposed on end 18 of bottom 14 of box 10. In the embodiment of FIG. 3 label 16 is made of a single integral piece of clear plastic which has been molded or formed to include a curved hanger portion 18 integral with a back panel 20 descending and curving to form bottom portion 22 and then ascending to form front panel 24.

Label 16 of the embodiment to FIG. 3 is better shown in the perspective view of FIG. 4. The embodiment to FIG. 4 differs from that of FIG. 2 in many respects including the absence of any side panels 26. Moreover, front panel 22 has been molded to include a curvilinear portion 36, which bends backwardly toward back panel 20 and functions as a compression clip to press photograph 28 between front and back panels 24 and 20 respectively. Similarly, hanger 18 is provided with an inwardly curving portion 38 that similarly acts as a compression clip to provide an enhanced fiction fit of label 16 against end 18 of box 10.

Another embodiment of label 16 is shown in FIG. 5 in perspective view. In the embodiment to FIG. 5, front panel 24 has had a central portion 40 removed or more properly not defined leaving integrally formed front side rails 42. Photograph 28 can thus be placed in the pocket defined between back panel 20 and front rails 22 resting on curved bottom 22. In addition, upper edges 17 of sides 26 may be modified curved or slope downwards from back panel 20 as opposed to the perpendicular extension shown on the embodiment of FIG. 2.

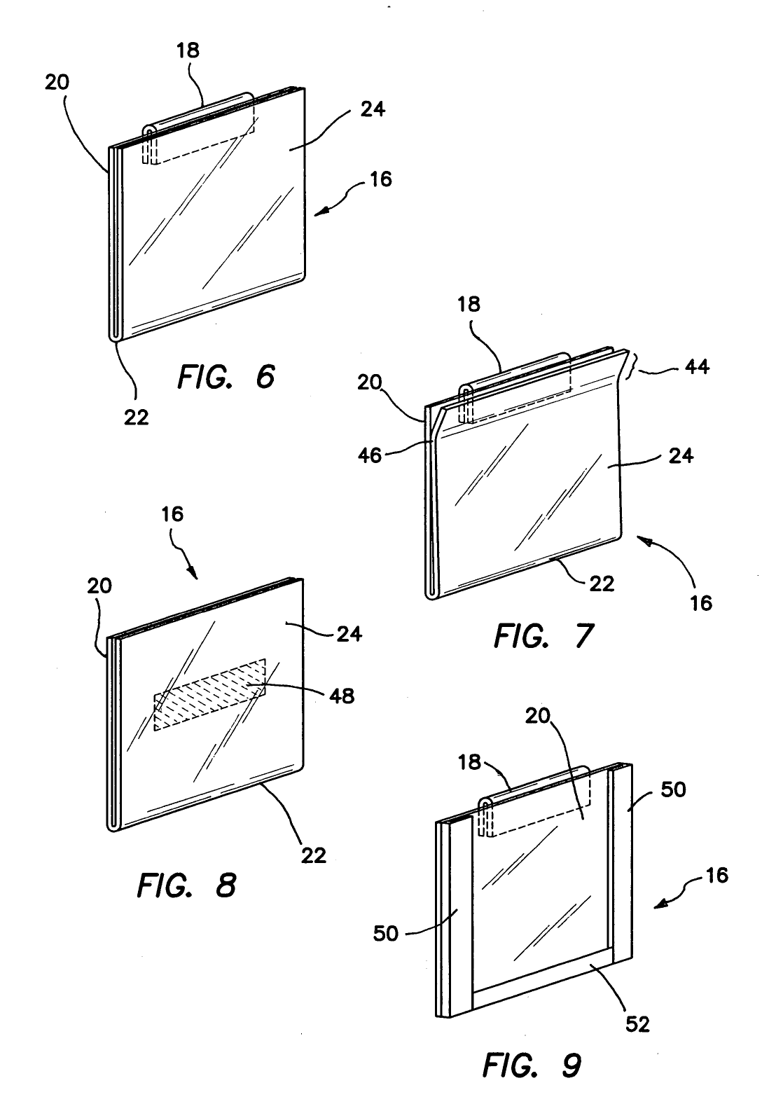

FIG. 6 is perspective view of yet another embodiment of label 16 which has been simplified to be comprised of a folded plate of clear plastic comprised of a front panel 24 folded to form a curved bottom 22 and a back panel 20. A U-shape prismatic intrusion 18 serves as a hanger and is glued, adhered or thermally welded to the back surface of panel 20. In the embodiment of FIG. 6 the separation between back and front panels 20 and 24 is small enough such that photograph 28 is compressed between them and held in place.

Yet another embodiment is shown in the perspective view of FIG. 7, which is substantially the same as that shown in FIG. 6, with exception that front panel 24 has an upper lip portion 44 which is bent outwardly toward the front to more easily accept the photograph 28 (not shown) and also to define a bend 46 which functions as a compression clip to better secure photograph 28 between front and back panels 20 and 24 respectively.

Yet another embodiment is shown in FIG. 8 in which label 16 has been simplified to a U-shape fold comprised of back panel 20, front panel 24 and connecting curved bottom 22. Mounting of label 16 to box 10 in this case is provided by means of a double-sided sticky adhesive tape segment 48 mounted on the back surface of back panel 20. In must be understood that adhesive may replace hanger 18 in all of the embodiments and that the compressing clips, such as clip 46 from portion 44 in the embodiment to FIG. 7 or the clip formed by bend 36 in the embodiment of FIG. 4, can be substituted into the embodiment to FIG. 8.

Still yet another embodiment is shown in the perspective view of FIG. 9. Label 16 in this embodiment is manufactured from separate pieces instead of the more integral embodiments of FIGS. 1-8. In the embodiment to FIG. 9 label 16 is comprised of a separate back panel 20 to which front extruded rails 50 are glued, adhered or thermally welded together with a bottom supporting shelf 52. Hanger 18 is affixed to the rear surface of back panel 20 in the manner similar to that described in connection with the embodiments of FIGS. 6 and 7. Alternatively, bottom shelf 52 may be integrally formed with back panel 20.

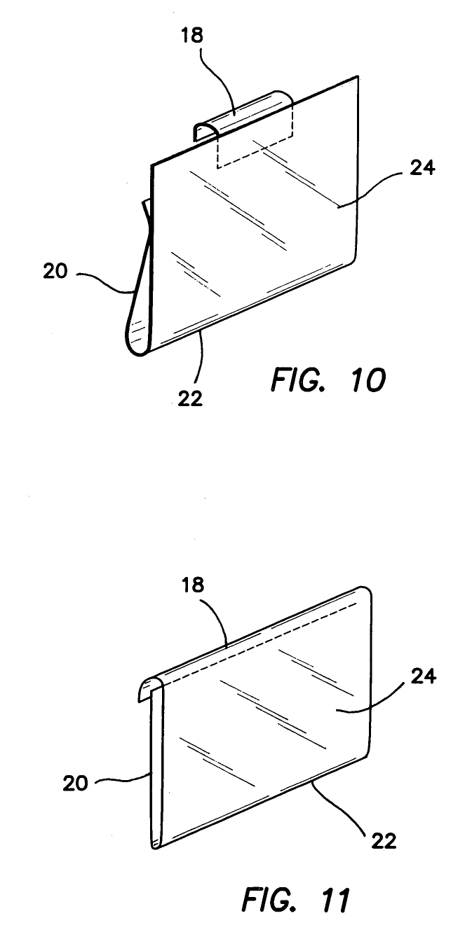

FIG. 10 is a perspective view of another embodiment of the invention in which hanger 18 is glued to or extruded from front panel 24 of label 16. Front panel 24 is integral with bottom portion 22 and back panel 20. Back panel 20 extends only partially up the vertical height of front panel 24 leaving an upper margin to which a prismatic U-shaped extruded hanger 18 may be fixed. Front and back panels 24 and 20 respectively are closely enough spaced or at least inwardly resiliently biased toward each other at least at their upper portions to provide friction engagement with a card or photo placed between them.

Alternatively FIG. 11 shows a perspective view of another embodiment of the invention similar to that shown in FIG. 10 except in this case hanger 18 is formed by backwardly curving the entire upper portion of front panel 24 of label 16.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

I claim:

1. A pictorial label for use of the shoebox comprising:
an image of at least one shoe can be stored in such shoebox; and
a holder for receiving said image attached to such shoebox, said holder being attachable by a user and said holder adapted to receive said image at a point of sale.

2. The label of claim 1 when said holder comprises a pocket for containing said image and a hanger for attachment to said shoebox.

3. The label of claim 2 wherein said pocket comprises a containment closed on five sides and opened on an upper sixth side through which said image is inserted.

4. The label of claim 2 wherein said pocket comprises a containment comprised of a back panel, a front panel and a bottom portion between said front and back panels, said bottom portion supporting said image while said front and back portions maintain said image there between.

5. The label of claim 4 wherein said containment further comprises a clip to fictionally engage said image to retain said image within said containment.

6. The label of claim 3 wherein said containment is integrally formed.

7. The label of claim 3 wherein said containment is comprised of separate pieces fixed together.

8. The label of claim 4 wherein said holder has a front portion and said front panel of said containment comprises a single integral panel extending across substantially said entire front portion of said holder.

9. The label of claim 4 wherein said front panel of said containment is comprised of two spaced apart front rails for retaining said image therein.

10. The label of claim 2 wherein said pocket has a back and wherein said hanger comprises an integral extension of said back of said pocket.

11. The label of claim 2 wherein said hanger comprises a back and a separate extrusion fixed to said back of said pocket.

12. The label of claim 2 where said pocket has a back surface and said hanger comprises double sticky tape adhered to said back surface of said pocket.

13. The label of claim 1 wherein said holder has indicia areas on a front surface thereof for display of markings.

14. A method providing a pictorial label for merchandise enclosed within a container at the point of sale comprising:
creating a tangible record of an image at least a portion of said merchandise to provide a pictorial depiction thereof;
disposing said record within a holder, said holder permitting visual display of said record; and
attaching said holder to said container of said merchandise.

15. The method of claim 14 where said container defines at least one edge and where attaching said holder to said container comprises hanging said holder on an edge of said container.

16. The method of claim 14 where said container has at least one exterior surface adapted for visual presentation to a user and where attaching said holder to said container comprises adhering said holder to said exterior surface.

17. A method performable at the point of sale for providing a photographic label for shoes enclosed within an original shoebox comprising the steps of:
photographing at least one shoe contained within said shoebox to display characteristics of said shoe, which displayed characteristics are used for selection of said shoe for wearing;
disposing said photograph within a holder, said holder permitting visual display of said photograph; and
attaching said holder to an end of said shoebox to visually display said shoes intended to be stored within said shoebox.

18. The method of claim 17 comprising attaching said holder to an end of said shoebox by a mechanical hanger extending over an edge of said shoebox.

19. The method of claim 17 comprising attaching said holder to an end of said shoebox by a segment of double sticky tape adhered to said holder and to said end of said shoebox.

20. The method of claim 17 comprising disposing said photograph within a holder by frictionally engaging said photograph between two panels, one of which is substantially transparent to allow visual display of said photograph.
